(19) United States
(12) Patent Application Publication
(10) Pub. No.: US 2016/0105509 A1
(43) Pub. Date: Apr. 14, 2016

(54) METHOD, DEVICE, AND MEDIUM

(71) Applicant: FUJITSU LIMITED, Kawasaki-shi (JP)

(72) Inventor: Ken Iizawa, Yokohama (JP)

(73) Assignee: FUJITSU LIMITED, Kawasaki-shi (JP)

(21) Appl. No.: 14/881,959

(22) Filed: Oct. 13, 2015

(30) Foreign Application Priority Data
Oct. 14, 2014 (JP) 2014-210297

(51) Int. Cl. H04L 29/08; H04L 12/26

(52) U.S. Cl. CPC H04L 67/1095; H04L 43/0882

(57) ABSTRACT

A control device includes: a memory configured to store data to be stored in a plurality of server apparatuses; and a processor configured to receive, from each of the plurality of server apparatuses, load information indicating degree of load for reading target data from a storage area included in each of the plurality of server apparatuses, the target data being stored as a mirroring data in each of the plurality of server apparatuses at a different portion of each respective storage area, and determine, based on the load information received from each of the servers, a server apparatus, among the plurality of server apparatuses, from which the target data is read.

### CROSS-REFERENCE TO RELATED APPLICATION

This application is based upon and claims the benefit of priority of the prior Japanese Patent Application No. 2014-210297, filed on Oct. 14, 2014, the entire contents of which are incorporated herein by reference.

### FIELD

The embodiment discussed herein is related to a method, a device, and a medium.

### BACKGROUND

Conventionally, there are techniques for reducing a load imposed in reading data stored in a storage area. As a related art, for example, there is a technique in which a plurality of read commands is sorted to a plurality of disk devices, based on a predictive value of a processing time of a read command, which is set based on a maximum seek time and a maximum rotating time for a plurality of disk devices, such that the processing time is uniform. Also, there is a technique in which a content distribution request is received from a request source, different parts of requested contents are obtained from a server (server apparatus) that holds a duplicate of contents distributed by a distribution server and the distribution server in parallel, and the obtained parts of the contents are relayed to the request source so as to be consecutive. Another related art is a technique in which subdivided data obtained by dividing divided data is stored in a disk 1 and a duplicate of the subdivided data is stored in disk 2 that is different from the disk 1 and is also different from an original disk, and a request for processing using the subdivided data is allocated to each of a device having the disk 1 and a device having the disk 2 in consideration of a load status. A still another related art is a technique in which synchronization with an interval reflected by the current position of a sliding write window is performed and the data is transmitted only when the data to be written conforms to a current interval of the window.

However, according to the related arts, it is difficult to reduce a load imposed in reading target data from one of a plurality of servers that store data through mirroring. Specifically, for example, if storage contents of blocks obtained by dividing a storage area of each server is the same among the plurality of servers, it is highly likely that a load imposed in reading in each server is the same among the servers, from whichever of the servers the read target data is read. Thus, if a load imposed in reading in each server is the same among the servers, from whichever of the servers read target data is read, there is not a server in which a load imposed in reading is relatively low, and therefore, it is difficult to reduce a load imposed in reading read target data from one of the plurality of servers.

As examples of related arts, Japanese Laid-open Patent Publication No. 09-258907, Japanese Laid-open Patent Publication No. 2003-283538, Japanese Laid-open Patent Publication No. 2000-322292, and Japanese Laid-open Patent Publication No. 2012-113705 are known.

### SUMMARY

According to an aspect of the invention, a control device includes: a memory configured to store data to be stored in a plurality of server apparatuses; and a processor configured to receive, from each of the plurality of server apparatuses, load information indicating degree of load for reading target data from a storage area included in each of the plurality of server apparatuses, the target data being stored as a mirroring data in each of the plurality of server apparatuses at a different portion of each respective storage area, and determine, based on the load information received from each of the servers, a server apparatus, among the plurality of server apparatuses, from which the target data is read.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating an example of an operation of a storage control device according to an embodiment;

FIG. 2 is a diagram illustrating a detailed example of a storage system;

FIG. 3 is a block diagram illustrating a hardware configuration example of the storage control device;

FIG. 4 is a block diagram illustrating a hardware configuration example of a server;

FIG. 5 is a block diagram illustrating a hardware configuration of a client device;

FIG. 6 is a block diagram illustrating a functional configuration example of the storage control device;

FIG. 7 is a block diagram illustrating a functional configuration example of the server;

FIG. 8 is a diagram illustrating an example of a write request;

FIG. 9 is a diagram illustrating an example of stream data;

FIG. 10 is a diagram illustrating an example of a retrieval request;

FIG. 11 is a diagram illustrating an example of an operation of a flush performed in write processing;

FIG. 12 is a diagram illustrating an example of sorting performed in write processing;

FIG. 13 is a diagram illustrating an example of event data management information;

FIG. 14 is a diagram illustrating an example of an operation performed in read processing;

FIG. 15 is a flow chart illustrating an example of initialization processing procedures;

FIG. 16 is a flow chart illustrating an example of write processing procedures; and

FIG. 17 is a flow chart illustrating an example of read processing procedures.

### DESCRIPTION OF EMBODIMENTS

According to an aspect, it is an object of the various embodiments to provide a method, a device, and a recording medium that allow reduction in load imposed in reading read target data from one of a plurality of servers that store data through mirroring.

Various embodiments of a method, a device, and a recording medium disclosed herein will be described in detail below with reference to the accompanying drawings.

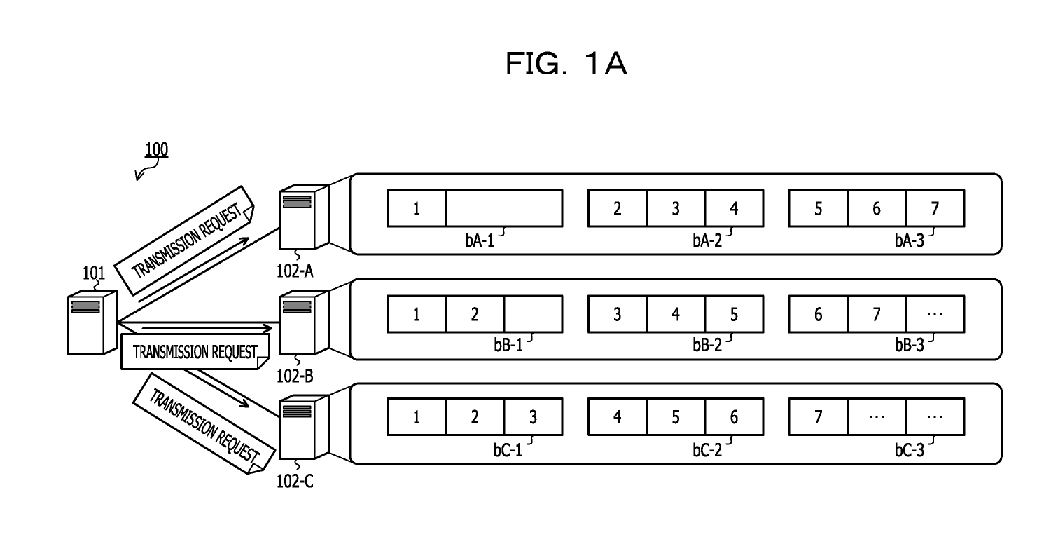

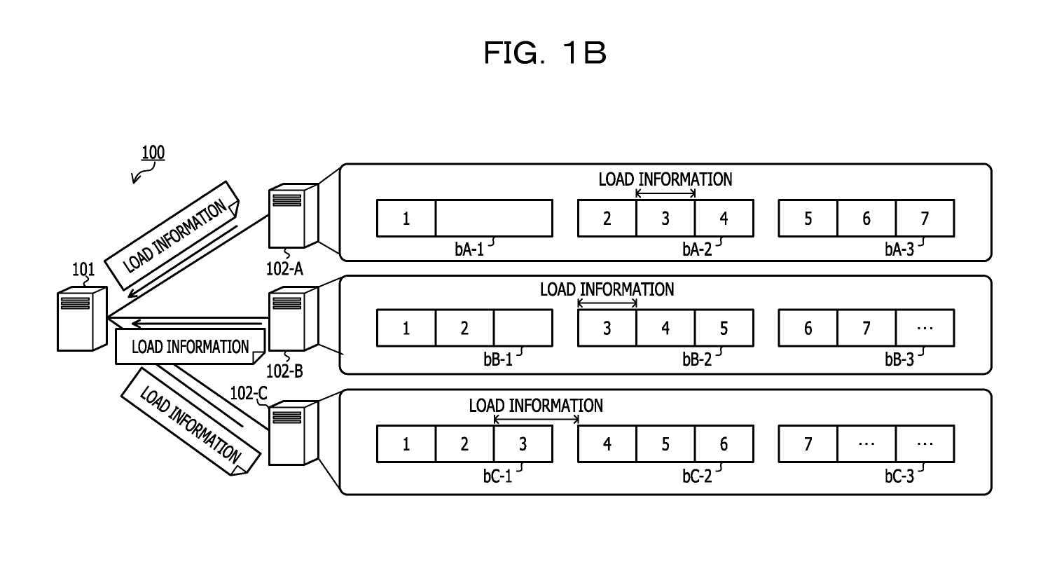

FIGS. 1A and 1B are diagrams illustrating an example of an operation of a storage control device 101 according to an embodiment. The storage control device 101 included in a storage system 100 is a computer that controls storage contents of a plurality of servers 102 coupled to the storage control device 101. In FIGS. 1A and 1B, as the plurality of servers 102, three servers, that is, a server 102-A, a server 102-B, and a server 102-C, are provided. The servers 102-A, 102-B, and 102-C store a plurality of pieces of data through mirroring in order to ensure reliability. Mirroring is a technique in which an original and a duplicate of the original are stored in a plurality of storage areas. The plurality of pieces of data may be any kind of data. For example, the plurality of pieces of data may be stream data, which is time-series data. Moreover, the data sizes of the plurality of pieces of data may be the same and may be different from one another.

In the servers 102-A, 102-B, and 102-C, each of the storage areas in which the plurality of pieces of data is stored may be any kind and, for example, may be a hard disk, a semiconductor memory, or a magnetic tape storage. In this embodiment, each of the storage areas in which the plurality of pieces of data is stored is a hard disk.

In this embodiment, it is assumed that the plurality of pieces of data is stream data. Also, it is assumed that data is event data. The “event data” used herein represents data indicating that some event occurred. For example, stream data is packets that flow via an Internet Protocol (IP) address and are captured at the IP address, and each of the packets is event data. For example, some event data is data indicating that a transmission control protocol (TCP) packet flowed at a certain time.

In this case, it is difficult to reduce a load imposed in reading read target data from one of the plurality of servers that store data through mirroring. Specifically, for example, if the storage contents of blocks obtained by dividing a storage area of each server are the same among the plurality of servers, it is highly likely that a load imposed in reading in each server is the same among the servers, from whichever of the servers the read target data is read. Thus, if a load imposed in reading in each server is the same among the servers, from whichever of the servers read target data is read, there is not a server in which a load imposed in reading is relatively low, and therefore, it is difficult to reduce a load imposed in reading read target data from one of the plurality of servers.

Also, because of a hard disk configuration, if, while a write access to a hard disk on a hard disk is made, a read access to the same hard disk is made, a head travels a large distance and a write performance is largely reduced. In this case, a problem arises particularly in a system in which many write operations are performed. In this case, a load imposed in reading in a server is, for example, a time which it takes to perform reading. If the storage areas in which a plurality of data is stored are hard disks, the load may be a head travel distance.

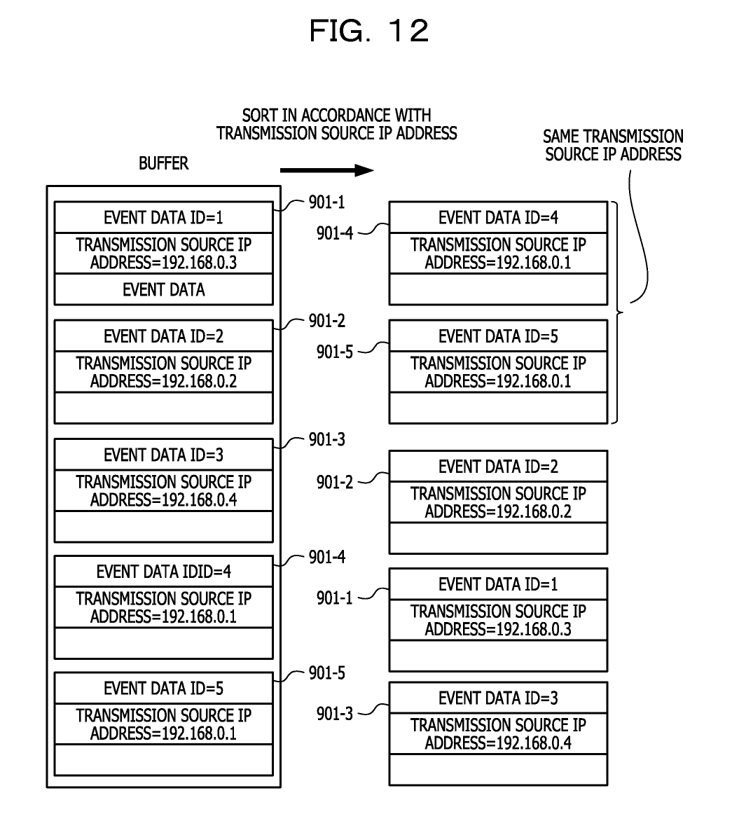

In order to reduce a load imposed in reading in the storage system 100, when a server writes event data, the server does not write event data in a hard disk in order of reception of the event data but temporarily stores event data in a buffer of the server. Then, when the buffer is full, the server sorts (rearranges) event data in accordance with predetermined metadata, and then, writes the event data in the hard disk. Writing of data in a buffer in a storage area will be hereinafter referred to as a “flush”. The predetermined metadata will be described later with reference to FIG. 12. In general, there are less cases where all pieces of event data, which are temporarily consecutive, are read and, in many cases, pieces of event data, which have the same metadata value or consecutive metadata values in a certain time, are read. Thus, a load imposed in reading event data, which is a read target, in a server may be reduced by sorting pieces of event data in accordance with metadata that is retrieved with high frequency.

However, if two pieces of event data received at timings between which a flush is performed are read targets, the two pieces of event data are written in positions that are distant from each other in a hard disk, although the two pieces of event data are temporarily consecutive and have the same metadata value.

Then, the storage control device 101 determines a server from which data is read based on a load imposed in reading data in each of the servers that store data through mirroring such that the storage contents of blocks differ among the servers. Thus, the storage contents of blocks differ among the servers, loads differ among the servers, and therefore, data may be read from one of the servers in which a load is small, so that a load imposed in reading read target data from one of the plurality of servers that store data through mirroring may be reduced.

A specific operation will be described with reference to FIGS. 1A and 1B. In FIG. 1A, the servers 102-A, 102-B, and 102-C store a plurality of pieces of data through mirroring. Furthermore, the servers 102-A, 102-B, and 102-C store a plurality of pieces of data such that the storage contents of blocks obtained by dividing a hard disk of each of the servers 102-A, 102-B, and 102-C in accordance with a predetermined data size differ among the servers 102-A, 102-B, and 102-C. In this case, the predetermined data size is the data size of a buffer. The data size of a buffer is preferably, for example, an integral multiple of an access unit of a hard disk. In examples of FIGS. 1A and 1B, it is assumed that the data size of a buffer corresponds to the size of three pieces of event data.

In FIG. 1A, the server 102-A stores event data 1 in a block bA-1, stores event data 2, event data 3, and event data 4 in a block bA-2, and stores event data 5, event data 6, and event data 7 in a block bA-3. The server 102-B stores event data 1 and event data 2 in a block bB-1, stores event data 3, event data 4 and event data 5 in a block bB-2, and stores event data 6, event data 7, . . . in a block bB-3. The server 102-C stores event data 1, event data 2, and event data 3, in a block bC-1, stores event data 4, event data 5, and event data 6 in a block bC-2, and stores event data 7, . . . in a block bC-3.

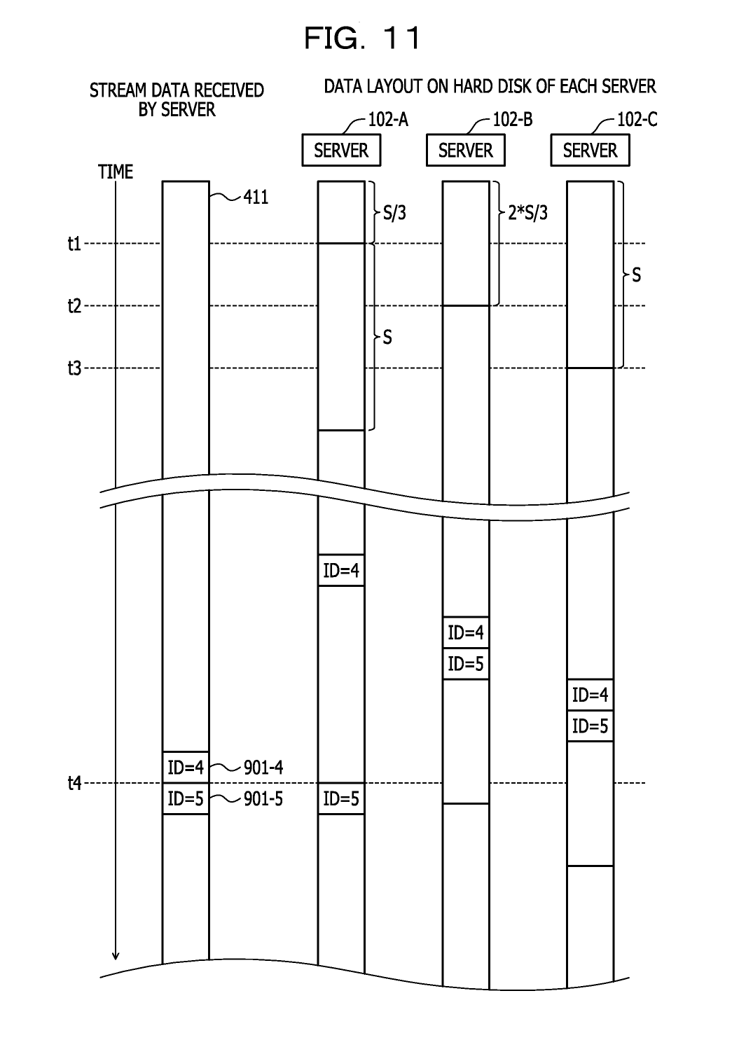

As described above, as a method for storing data such that the storage contents of blocks differ among the servers 102-A, 102-B, and 102-C, for example, when the servers 102-A, 102-B, and 102-C receive event data on a real-time basis, for example, a timing of a flush may be set different among the servers 102-A, 102-B, and 102-C. Specifically, the timing of a first flush for the server 102-A is set to be a time when the data amount of a buffer reaches 1/3, the timing of a first flush for the server 102-B is set to be a time when the data amount of a buffer reaches 2/3, and the timing of a first flush for the server 102-C is set to be a time when the data amount of a buffer is full. A more detailed example will be described later with reference to FIG. 11.

In reading read target data from the servers 102-A, 102-B, and 102-C, the storage control device 101 transmits a transmission request for transmitting load information indicating the degree of a load imposed in reading the read target data to the servers 102-A, 102-B, and 102-C. In the example of FIG. 1A, the storage control device 101 transmits a transmission request for transmitting load information indicating the degree of a load in reading the event data 3 and the event data 4 as read target data to the servers 102-A, 102-B, and 102-C.

Next, in FIG. 1B, when the servers 102-A, 102-B, and 102-C receive the transmission request for transmitting load information, each of the servers 102-A, 102-B, and 102-C generates load information, based on a storage position in which the read target data is stored in the corresponding hard disk. Information used as the storage position may be the address of a storage area and may be a block.

For example, each of the servers 102-A, 102-B, and 102-C generates as load information a head travel distance which a head of the corresponding hard disk travels for reading the event data 3 and the event data 4. In the servers 102-A and 102-B, the event data 3 and the event data 4 are stored in the same block, and therefore, the head travel distance is small. In contrast, in the server 102-C, the event data 3 and the event data 4 are stored in different blocks, and therefore, the head travel distance is large. A reason why, when pieces of event data are stored in different blocks, the head travel distance is large is that the different blocks might be arranged in parts that are distant from each other in the hard disk. Also, when the above-described sorting is performed, although the different blocks are arranged in consecutive parts, as a result of the sorting, the event data 3 and the event data 4 might be located distant from each other.

After generating the load information, the servers 102-A, 102-B, and 102-C transmit the load information to the storage control device 101. The storage control device 101 determines, among the servers 102-A, 102-B, and 102-C, a server from which read target data is read, based on the load information received from the servers 102-A, 102-B, and 102-C. In the example of FIG. 1B, the storage control device 101 reads the event data 3 and the event data 4 from one of the servers 102-A and 102-B in which the load information is small.

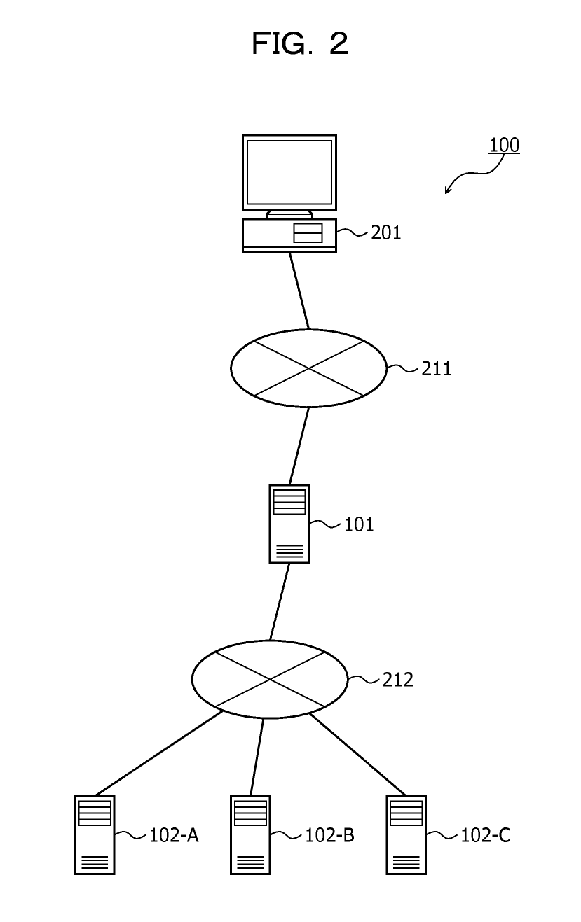

In the examples of FIGS. 1A and 1B, two pieces of read target data are read, but the number of pieces of read target data may be three or more, and may be one. Even when the number of pieces of read target data is one, the storage contents of blocks differ among the servers 102-A, 102-B, and 102-C, and therefore, there might be a situation where some event data, which is a read target, fits in one block in one of the servers, while the event data is divided into two blocks in another one of the servers. Specifically, when the data size of some event data is larger than a normal size, the event data tends to be divided into two blocks. In this case, the load information received from the servers 102-A, 102-B, and 102-C differ among the servers 102-A, 102-B, and 102-C, and therefore, the storage control device 101 may reduce the load of the storage system 100 by determining one of the servers in which the load information is the smallest as a server from which the event data is read. Next, a detailed example of the storage system 100 will be described with reference to FIG. 2.

FIG. 2 is a diagram illustrating a detailed example of the storage system 100. The storage system 100 includes a client device 201, the storage control device 101, the servers 102-A, 102-B, and 102-C. The client device 201 is coupled to the storage control device 101 via a network 211. The storage control device 101 is coupled to the servers 102-A, 102-B, and 102-C via a network 212.

The client device 201 is a computer that transmits a write request, a retrieval request, and a read request to the storage control device 101 in accordance with an operation of a user of the storage system 100 or the like. An operation performed in transmitting a write request, a retrieval request, and a read request will be described below.

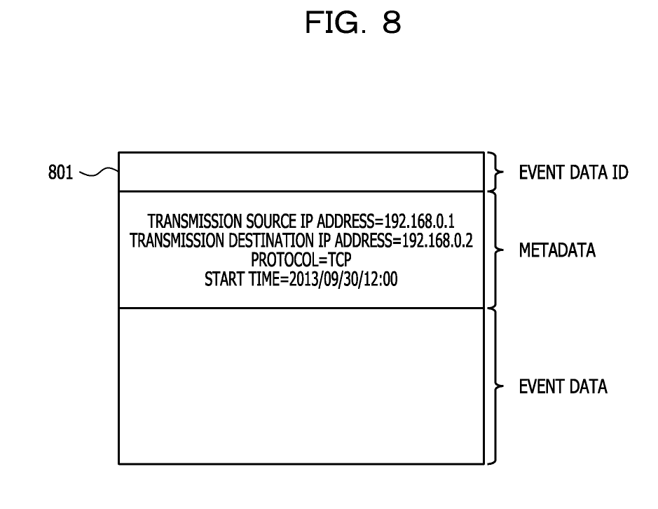

As for a write request, the client device 201 forms event data from received stream data and transmits a write request including the event data to which an event data identifier (ID) that uniquely identifies the event data is given to the storage control device 101. A specific example of a write request will be described later with reference to FIG. 8. The storage control device 101 that received the write request transfers the write request to the servers 102-A, 102-B, and 102-C. The servers 102 that received the write request execute write processing. Write processing will be described later with reference to FIG. 11 and FIG. 12.

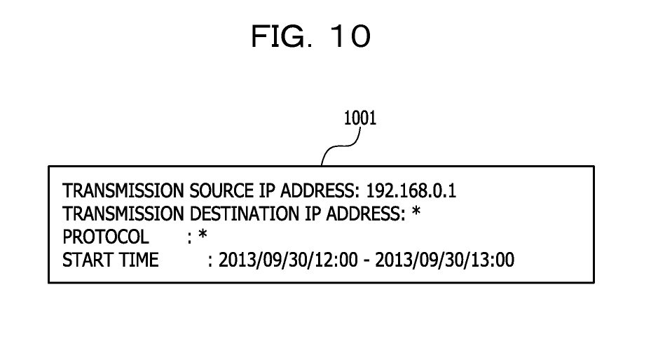

As for the retrieval request, the client device 201 transmits a retrieval request including a retrieval condition designated by the user of the storage system 100 or the like to the storage control device 101. A specific example of the retrieval request will be described later with reference to FIG. 10.

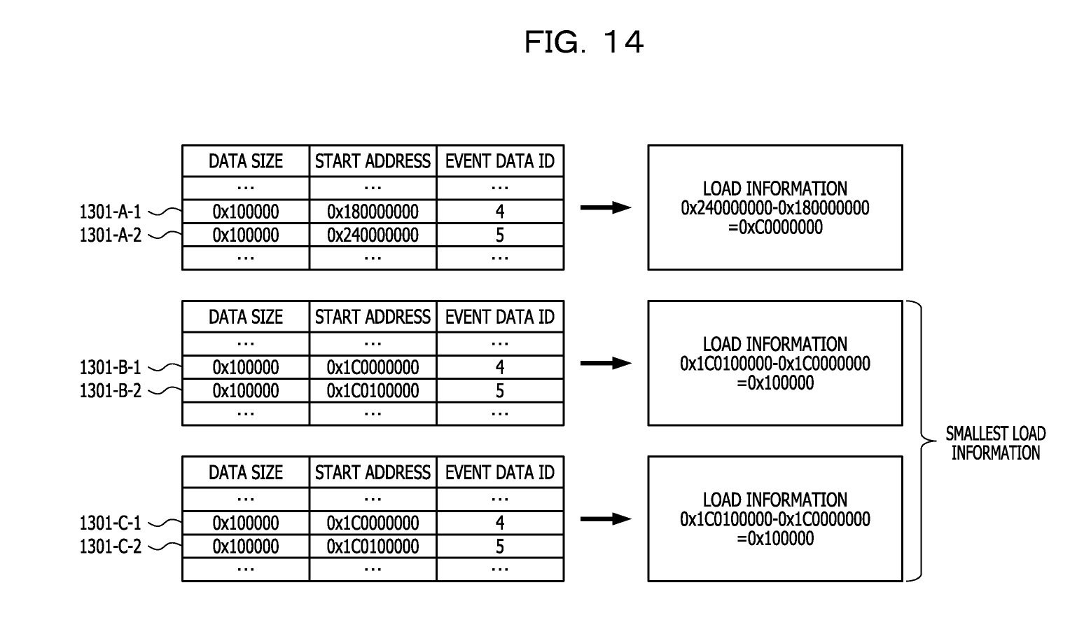

As for a read request, the client device 201 transmits a read request for reading, as a read target, a part or a whole of the event data ID acquired as a result of retrieval performed in accordance with the retrieval request to the storage control device 101. The read request only includes the event data ID of a read target, and therefore, is not specifically illustrated. The storage control device 101 that received the read request performs read processing in cooperation with the servers 102-A, 102-B, and 102-C. The read processing will be described later with reference to FIG. 14.

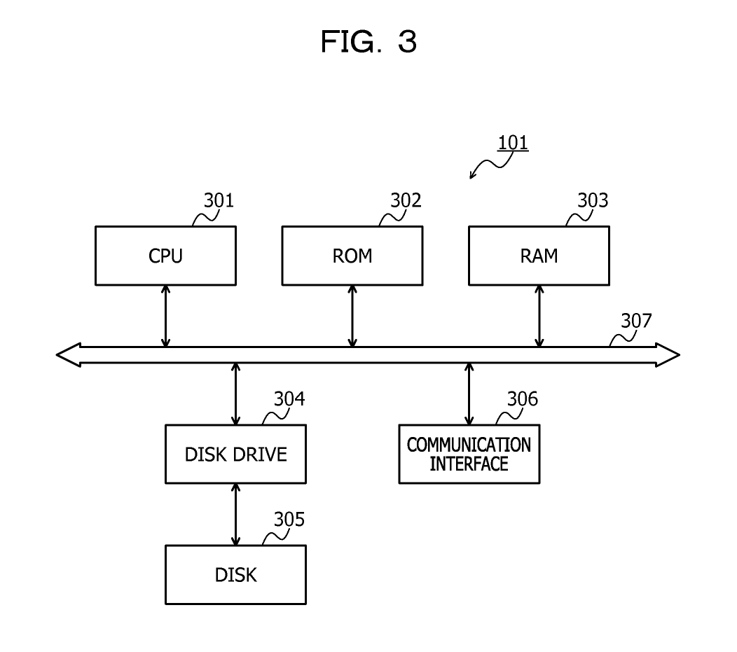

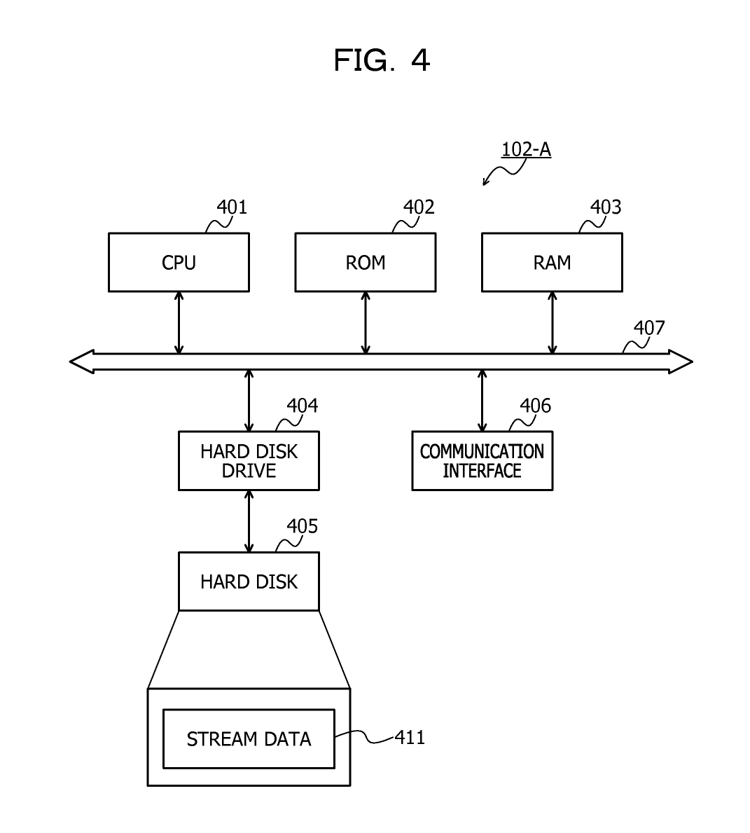

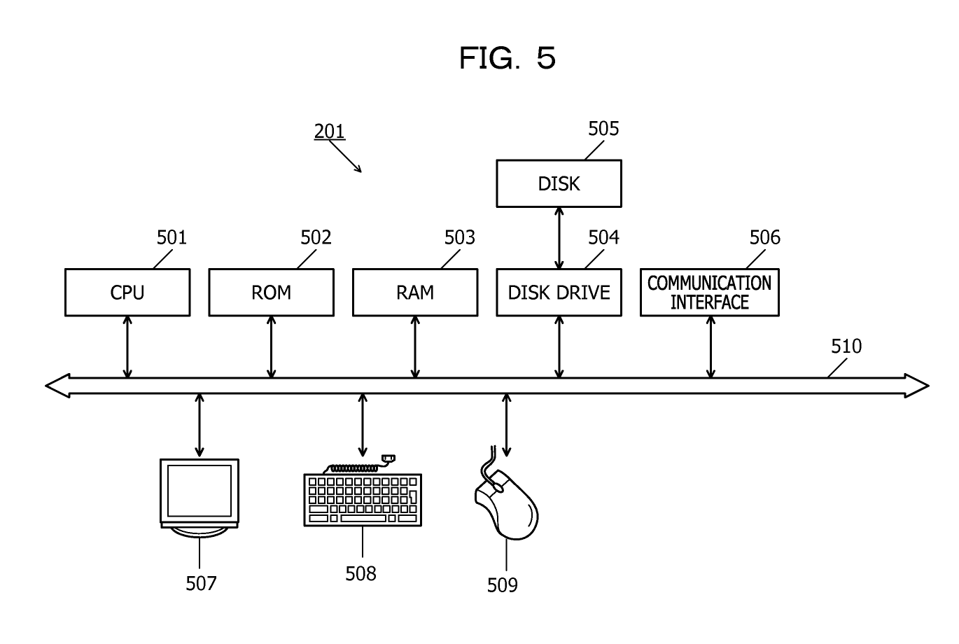

The storage control device 101 is a proxy server that receives a write request, a retrieval request, and a read request from the client device 201 and performs processing. Next, hardware configurations of the storage control device 101, the server 102, and the client device 201 will be described with reference to FIG. 3, FIG. 4, and FIG. 5.

FIG. 3 is a block diagram illustrating a hardware configuration example of the storage control device 101. In FIG. 3, the storage control device 101 includes a central processing unit (CPU) 301, a read only memory (ROM) 302, and a random access memory (RAM) 303. The storage control device 101 includes a disk drive 304, a disk 305, and a communication interface 306. The CPU 301, the ROM 302, the RAM 303, and the disk drive 304, and the communication interface 306 are coupled with one another via a bus 307.

The CPU 301 is an arithmetic processing device that performs control of the entire storage control device 101. The ROM 302 is a nonvolatile memory that stores a program, such as a boot program. The RAM 303 is a volatile memory used as a work area of the CPU 301.

The disk drive 304 is a control device that controls read and write of data from and to the disk 305 in accordance with control of the CPU 301. As the disk drive 304, for example, a magnetic disk drive, a solid state drive, or the like, may be employed. The disk 305 is a nonvolatile memory that stores data written by control of the disk drive 304. For example, when the disk drive 304 is a magnetic disk drive, a magnetic disk may be used as the disk 305. When the disk drive 304 is a solid state drive, a semiconductor memory, that is, a so-called semiconductor disk, which includes a semiconductor element, may be used as the disk 305.

The communication interface 306 is a control device that controls a corresponding network and an internal interface to control input and output of data from and to another device. Specifically, the communication interface 306 is coupled to the another device via the network through a communication line. As the communication interface 306, for example, a modem, a LAN adapter, or the like, may be used.

When an administrator of the storage system 100 directly operates the storage control device 101, the storage control device 101 may include a hardware, such as a display, a keyboard, and a mouse.

FIG. 4 is a block diagram illustrating a hardware configuration example of the server 102. In FIG. 4, as an example of the server 102, a hardware configuration of the server 102-A is illustrated. Each of the server 102-B and the server 102-C has the same hardware configuration as that of the server 102-A. In FIG. 4, the server 102 includes a CPU 401, a ROM 402, and a RAM 403. The server 102 also includes a hard disk drive 404, a hard disk 405, and a communication interface 406. The CPU 401, the ROM 402, the RAM 403, the hard disk drive 404, and the communication interface 406 are coupled to one another via a bus 407.

The CPU 401 is an arithmetic processing device that performs control of the entire server 102. The ROM 402 is a nonvolatile memory that stores a program, such as a boot program and the like. The RAM 403 is a volatile memory used as a work area of the CPU 401.

The hard disk drive 404 is a control device that controls read and write of data from and to the hard disk 405 in accordance with control of the CPU 401. The hard disk 405 is a storage medium that stores data written by control of the hard disk drive 404. The server 102 may include, instead of the hard disk drive 404 and the hard disk 405, a solid state drive and a semiconductor memory including a semiconductor element. The hard disk 405 stores the stream data 411.

The communication interface 406 is a control device that controls a corresponding network and an internal interface and controls input and output of data from and to another device. Specifically, the communication interface 406 is coupled to the another device via the network through a communication line. As the communication interface 406, for example, a modem, a LAN adapter, or the like, may be used.

When the administrator of the storage system 100 directly operates the server 102, the server 102 may include a hardware, such as a display, a keyboard, and a mouse.

The buffer of each server illustrated in FIGS. 1A and 1B and the like may be the RAM 403, and may be a storage area different from the hard disk 405 of the hard disk drive 404.

FIG. 5 is a block diagram illustrating a hardware configuration example of the client device 201. The client device 201 includes a CPU 501, a ROM 502, and a RAM 503. The client device 201 includes a disk drive 504, a disk 505, and a communication interface 506. The client device 201 further includes a display 507, a keyboard 508, and a mouse 509. The CPU 501, the ROM 502, the RAM 503, the disk drive 504, the communication interface 506, the display 507, the keyboard 508, and the mouse 509 are coupled with one another via a bus 510.

The CPU 501 is an arithmetic processing device that performs control of the entire client device 201. The ROM 502 is a nonvolatile memory that stores a program, such as a boot program. The RAM 503 is a volatile memory used as a work area of the CPU 501.

The disk drive 504 is a control device that controls read and write of data from and to the disk 505 in accordance with control of the CPU 501. As the disk drive 504, for example, a magnetic disk drive, an optical disk drive, a solid state drive, or the like, may be employed. The disk 505 is a nonvolatile memory that stores data written by control of the disk drive 504. For example, when the disk drive 504 is a magnetic disk drive, a magnetic disk may be used as the disk 505. When the disk drive 504 is an optical disk drive, an optical disk may be used as the disk 505. When the disk drive 504 is a solid state drive, a semiconductor memory, that is, a so-called semiconductor disk, which includes a semiconductor element, may be used as the disk 505.

The communication interface 506 is a control device that controls a corresponding network and an internal interface and controls input and output of data from and to an external device. Specifically, the communication interface 506 is coupled to the another device via the network through a communication line. As the communication interface 506, for example, a modem, a LAN adapter, or the like, may be used.

The display 507 is a device that displays data, such as a document, an image, function information, and the like, as well as a mouse cursor, an icon, or a tool box. As the display 507, for example, a cathode ray tube (CRT), a thin film transistor (TFT) liquid crystal display, a plasma display, or the like, may be employed.

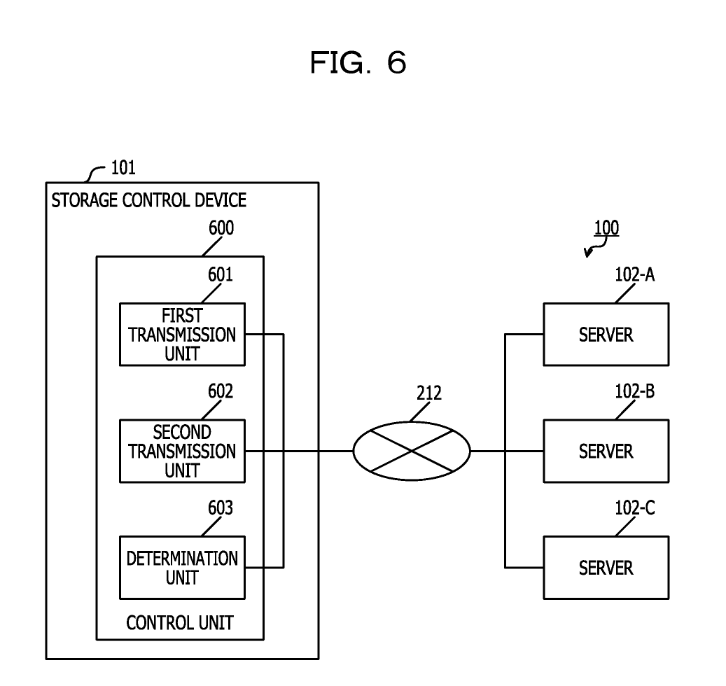

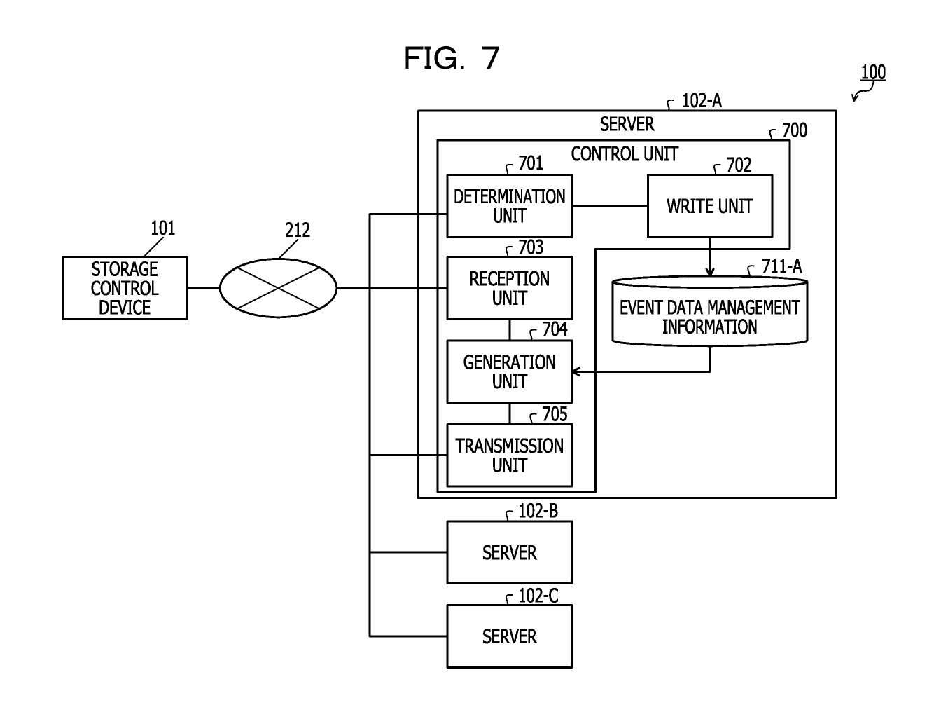

The keyboard 508 is a device that includes keys used for inputting a character, a number, various instructions and performs data input. The keyboard 508 may be a touch panel type input pad, a numerical keypad, or the like. The mouse 509 is a device that moves a mouse cursor, selects a range, moves a window, changes a window size, and performs like operation. The mouse 509 may be a trackball, a joy stick, or the like, as long as the mouse 509 similarly has a similar as a pointing device. Next, functional configurations of the storage control device 101 and the server 102 will be described with reference FIG. 6 and FIG. 7.

FIG. 6 is a block diagram illustrating a functional configuration example of the storage control device 101. The storage control device 101 includes a control unit 600. The control unit 600 includes a first transmission unit 601, a second transmission unit 602, and a determination unit 603. The CPU 301 executes a program stored in a storage device, and thereby, the control unit 600 realizes a function of each unit. Specifically, the storage device is, for example, the ROM 302, the RAM 303, the disk 305, or the like, illustrated in FIG. 3. A processing result of each unit is stored in a register of the CPU 301, a cache memory of the CPU 301, or the like.

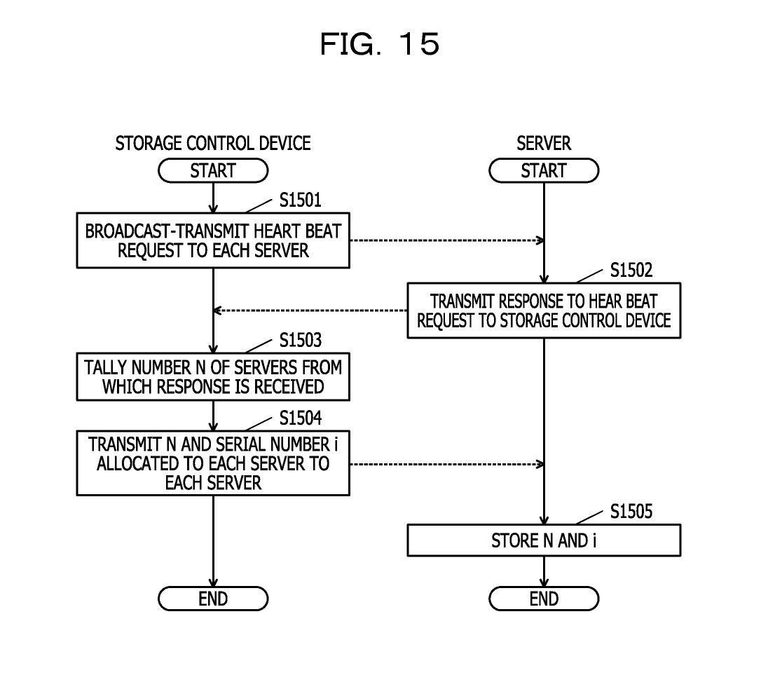

In writing one of pieces of data of the stream data 411 in the servers 102-A, 102-B, and 102-C, the first transmission unit 601 transmits an instruction for determining a block in which the one of pieces of data of the stream data 411 is written to the servers 102-A, 102-B, and 102-C. Specific processing contents will be described later with reference to FIG. 11 and FIG. 15.

In reading read target data of the stream data 411, the second transmission unit 602 transmits a transmission request for transmitting load information indicating the degree of a load imposed in reading the read target data to the servers 102-A, 102-B, and 102-C. As has been described above, the load information may be the head travel distance and, if a storage area in which stream data is stored is a semiconductor disk, the load information may be the number of blocks used for performing reading. The load information may also be a time which it takes to perform reading. As a time calculation method, for example, each of the servers 102-A, 102-B, and 102-C calculates a time which it takes to perform reading with reference to information regarding a time which it takes to read data of a predetermined data size stored in advance. As another alternative, if a storage area in which stream data is stored is a magnetic tape storage, the load information may be a length for which a tape is moved.

The determination unit 603 determines a server, among the servers 102-A, 102-B, and 102-C, from which read target data is read, based on the load information received from the servers 102-A, 102-B, and 102-C. For example, if the load information is the head travel distance, the determination unit 603 determines, as a server from which read target data is read, a server in which the head travel distance is the smallest. For example, if the load information is the number of blocks used for performing reading, the determination unit 603 determines, as a server from which read target data is read, a server in which the number of blocks used for performing reading is the smallest.

Also, it is assumed that read target data includes two or more pieces of data of the stream data 411. In this case, the determination unit 603 determines, based on, as the load information, a difference among addresses each of which indicates a storage position in which read target data is stored in the corresponding one of the servers 102-A, 102-B, and 102-C, a server, among the servers 102-A, 102-B, and 102-C, from which read target data is read.

FIG. 7 is a block diagram illustrating a functional configuration example of the server 102. In FIG. 7, a functional configuration of the server 102-A will be described. Although not illustrated, each of the servers 102-B and 102-C has the same function as that of the server 102-A. The server 102 includes a control unit 700. The control unit 700 includes a determination unit 701, a write unit 702, a reception unit 703, a generation unit 704, and a transmission unit 705. The CPU 401 executes a program stored in a storage device, and thereby, the control unit 700 realizes a function of each unit. Specifically, the storage device is, for example, the ROM 402, the RAM 403, the hard disk 405, or the like, illustrated in FIG. 4. A processing result of each unit is stored in a register of the CPU 401, a cache memory of the CPU 401, or the like. The control unit 700 may be a function that the hard disk drive 404 has.

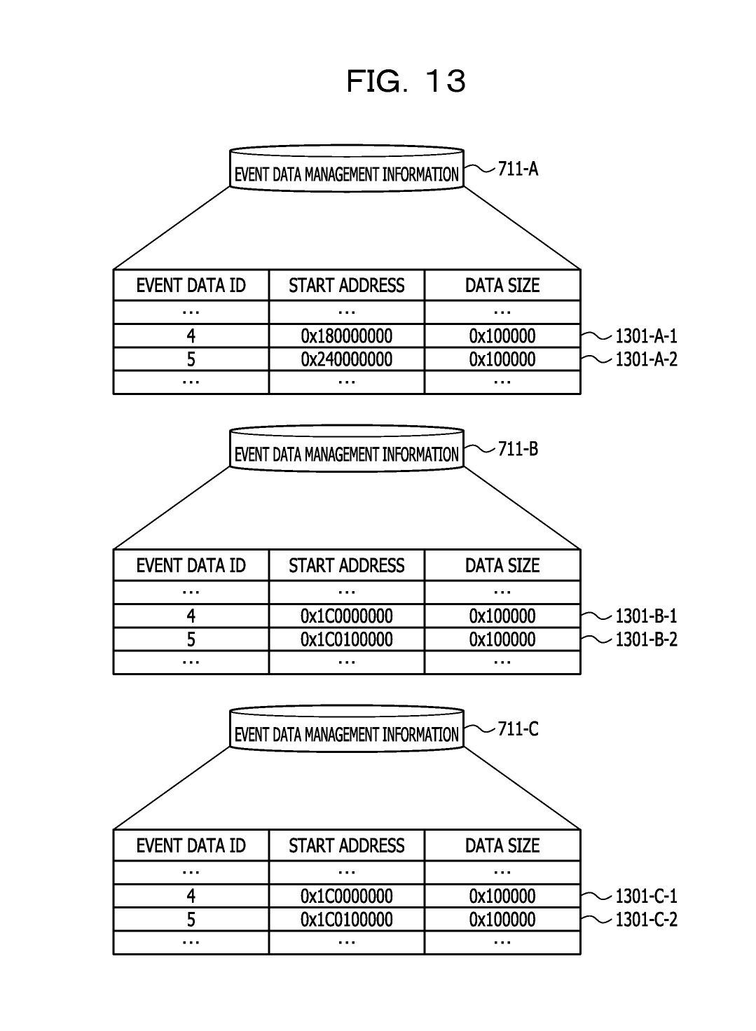

The server 102-A is capable of accessing event data management information 711-A. The event data management information 711 is stored in a storage device, such as the RAM 403. An example of storage contents of the event data management information 711 will be described later with reference to FIG. 13.

In response to reception of an instruction for determining a block in which one of pieces of data of the stream data 411 is written from the storage control device 101, the determination unit 701 determines, based on the number of the plurality of servers and integers allocated to the servers 102-A, 102-B, and 102-C, a block in which the one of pieces of data of the stream data 411 is written. In this case, the instruction is an instruction transmitted by the first transmission unit 601 in FIG. 6, as has been described.

It is assumed that each piece of data of the stream data 411 is data associated with a predetermined metadata value. In this case, the write unit 702 sorts (rearranges) two or more pieces of data of the stream data 411, which belongs to one of blocks obtained by dividing a storage area in accordance with a predetermined attribute value associated with each of the two or more pieces of data, and writes the sorted pieces of data in one of the blocks.

The reception unit 703 receives a transmission request for transmitting load information indicating the degree of a load imposed in reading read target data of the stream data 411.

When the generation unit 704 receives the transmission request, the generation unit 704 generates load information, for example, based on a storage position in which read target data is stored in a storage area. Information used as the storage position may be the address of a storage area and may be a block. The generation unit 704 may generate, as the load information, a difference among addresses each of which indicates a storage position in which read target data is stored in the corresponding one of the servers 102-A, 102-B, and 102-C. The transmission unit 705 transmits the generated load information to a request source of the transmission request.

FIG. 8 is a diagram illustrating an example of a write request. As illustrated in FIG. 8, a write request includes three pieces of data, that is, an event data ID, metadata, and event data. An event data ID is given by the client device 201 and is a value that identifies event data. Metadata is an attribute accompanying event data. Event data is data indicating that some event occurred.

For example, in the example of FIG. 8, a write request 801 indicates that the event data ID is 1, a transmission source IP address is “192.168.0.1”, a transmission destination IP address is “192.168.0.2”, and a protocol is “TCP”. The write request 801 also indicates that transmission of event data started at “2013/09/30/12:00”.

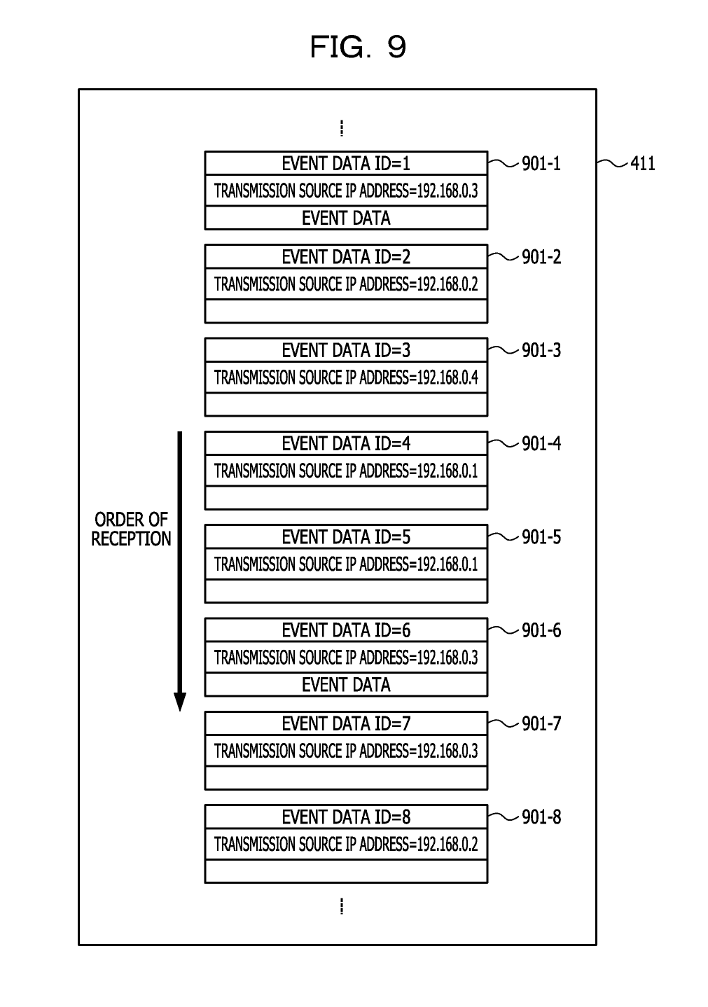

FIG. 9 is a diagram illustrating an example of the stream data 411. FIG. 9 illustrates an example of the stream data 411 written in the servers 102-A, 102-B, and 102-C in accordance with a write request. Event data, which is a part of the stream data 411 and reached the storage control device 101 first with a certain timing as starting point, is event data 901-1 the event data ID of which is 1. The event data 901-1 is event data the transmission source IP address of which is “192.168.0.3”. Then, event data 901-2, event data 901-3, event data 901-4, event data 901-5, event data 901-6, event data 901-7, and event data 901-8 follow, which are parts of the stream data 411 and reached the storage control device 101 second to eighth with the certain timing as a starting point and the event data IDs of which are 2 to 8.

In this case, each of the event data 901-4 and the event data 901-5 is event data the transmission source IP address of which is “192.168.0.1”. Each of the event data 901-2 and the event data 901-8 is event data the transmission source IP address of which is “192.168.0.2”. Each of the event data 901-1, the event data 901-6, and the event data 901-7 is event data the transmission source IP address of which is “192.168.0.3”. The event data 901-3 is event data the transmission source IP address of which is “192.168.0.4”.

FIG. 10 is a diagram illustrating an example of a retrieval request. FIG. 10 illustrates a retrieval request 1001 received by the storage control device 101 from the client device 201 after the stream data illustrated in FIG. 9 reached the storage control device 101. The storage control device 101 transmits the retrieval request 1001 to one of the servers 102-A, 102-B, and 102-C.

A retrieval request includes a retrieval condition. The retrieval condition designates a value of metadata. Specifically, for example, the retrieval condition designates one of values of a transmission source IP address, a transmission destination IP address, a protocol, and a start time.

In the example of FIG. 10, the retrieval request 1001 is a request for retrieving event data in a range where the transmission source IP address is “192.168.0.1” and the start time is “2013/09/30/12:00-2013/09/30/13:00”. Also, “*” indicated by the retrieval request 1001 is a wild card.

FIG. 11 is a diagram illustrating an example of an operation of a flush performed in write processing. With reference to FIG. 11, an example of an operation of a flush performed by the server 102 as a part of write processing in writing event data in accordance with a write request from the storage control device 101 will be described.

When the servers 102-A, 102-B, and 102-C receive a write request for writing some event data, which is a part of the stream data 411, the servers 102-A, 102-B, and 102-C store the event data in the respective buffers of the servers 102-A, 102-B, and 102-C. Then, if Expression 1 described below is true, the servers 102-A, 102-B, and 102-C perform a first flush.

Data amount in buffer≧S*i/N Expression 1

In Expression 1, S denotes the storage capacity of a buffer. Also, i is a value given to each of the servers 102-A, 102-B, and 102-C such that the value differs among the servers 102-A, 102-B, and 102-C are and, in this embodiment, 1, 2, and 3 are given to the servers 102-A, 102-B, and 102-C, respectively. The value of i is set by the storage control device 101 at initialization of the storage system 100. Also, N is the number of the servers 102. In this embodiment, N=3. By transmitting N and i, it is instructed to determine in which block each event data of the stream data 411 is written, based on N, i, and the data sizes of blocks.

For example, in the example of FIG. 11, at a time t1, the data amount in the buffer of the server 102-A is S/3 and Expression 1 is true, and therefore, the server 102-A performs a flush. On the other hand, at the time t1, for the servers 102-B and 102C, Expression 1 is false, and therefore, each of the servers 102-B and 102-C does not perform a flush. For the server 102-B, Expression 1 is true at a time t2 when the data amount in the buffer of the server 102-B is 2*S/3, and the server 102-B performs a flush. For the server 102-C, Expression 1 is true at a time t3 when the data amount in the buffer of the server 102-C is S, and the server 102-C performs a flush. As for timings at which second and subsequent flushes are performed, when the data amount in the corresponding buffer is S, the servers 102-A, 102-B, and 102-C perform a flush.

Next, the servers 102-A, 102-B, and 102-C sequentially receive the event data 901-4 and the event data 901-5 illustrated in FIG. 9. When the server 102-A receives the event data 901-4, the server 102-A performs a flush at a time t4. Accordingly, the server 102-A writes the event data 901-4 and the event data 901-5 in different blocks. On the other hand, each of the servers 102-B and 102-C does not perform a flush at the time t4, and therefore, writes the event data 901-4 and the event data 901-5 in the same block. In this case, in actually writing event data in blocks, the servers sort the event data and then write the event data. An example of sorting will be described later with reference to FIG. 12.

As illustrated in FIG. 11, the server 102-A stores the event data 901-4 and the event data 901-5 which are temporarily consecutive and have the same metadata value in positions that are distant from each other in the hard disk 405. In contrast, each of the servers 102-B and 102-C stores the event data 901-4 and the event data 901-5 in positions that are close to each other in the hard disk 405.

FIG. 12 is a diagram illustrating an example of sorting performed in write processing. FIG. 12 illustrates an example of sorting performed in write processing, using sorting performed by the server 102-B in writing the event data 901-1, the event data 901-2, the event data 901-3, the event data 901-4, and event data 901-5.

The server 102 sorts event data received in a certain period in accordance with specific metadata, and then, writes the event data in the hard disk 405. The specific metadata is set in advance by the administrator of the storage system 100. Specifically, the administrator of the storage system 100 designates in advance a metadata attribute, among a plurality of metadata attributes, which is expected to be the most frequently designated by a retrieval request. In the example of FIG. 12, the server 102-B sorts the event data 901-1, the event data 901-2, the event data 901-3, the event data 901-4, and the event data 901-5 stored in the buffer in accordance with the transmission source IP address. As a result of sorting, the server 102-B rearranges the event data 901-1, the event data 901-2, the event data 901-3, the event data 901-4, and the event data 901-5 in the order of the event data 901-4, the event data 901-5, the event data 901-2, the event data 901-1, and the event data 901-3, and then, writes them in the hard disk 405. Next, in FIG. 13, event data management information will be described using an example after the event data 901-1, the event data 901-2, the event data 901-3, the event data 901-4, the event data 901-5, the event data 901-6, the event data 901-7, and the event data 901-8 were written.

FIG. 13 is a diagram illustrating an example of event data management information 711. FIG. 13 illustrates the event data management information 711 in a state where the servers 102-A, 102-B, and 102-C receive the stream data 411 illustrated in FIG. 9, perform a flush and sorting in write processing illustrated in FIG. 11 and FIG. 12, and then, store the stream data 411. In the example of FIG. 13, event data management information 711-A includes records 1301-A-1 and 1301-A-2. Event data management information 711-B includes records 1301-B-1 and 1301-B-2. Similarly, event data management information 711-C includes records 1301-C-1 and 1301-C-2.

The event data management information 711 includes event data ID, start address, and data size fields. An event data ID of received event data is stored in the event data ID field. An address in which the received event data is written is stored in the start address field. A total data size of the received event data and metadata is stored in the data size field. Note that, in the example of FIG. 13, it is assumed that the servers 102-A, 102-B, and 102-C write event data and metadata in consecutive areas.

For example, in the example of FIG. 13, for the server 102-A, as illustrated by the records 1301-A-1 and 1301-A-2, the event data 901-4 and the event data 901-5 are stored in different blocks, and therefore, respective values of start addresses are greatly different from each other. In contrast, for the servers 102-B and 102-C, as illustrated by the records 1301-B-1 and 1301-B-2 and the records 1301-C-1 and 1301-C-2, the event data 901-4 and the event data 901-5 are stored in the same block, respective values of start addresses are close to each other. Next, an example of an operation performed when the event data 901-4 and the event data 901-5 the event data IDs of which are 4 and 5 are detected in accordance with the retrieval request 1001 illustrated in FIG. 10 and reading of the event data 901-4 and the event data 901-5 is performed will be described with reference to FIG. 14.

FIG. 14 is a diagram illustrating an example of an operation performed in read processing. As reading processing, the storage control device 101 transmits a transmission request for transmitting load information regarding a load imposed in reading read target data to each of the servers 102-A, 102-B, and 102-C. The servers 102-A, 102-B, and 102-C that received the transmission request for transmitting load information generate load information with reference to the event data management information 711. Then, the storage control device 101 determines a server from which read target data is read, based on the load information received from each of the servers 102-A, 102-B, and 102-C. In the example of FIG. 14, the storage control device 101 transmits as read target data a transmission request for transmitting load information regarding a load imposed in reading the event data 901-4 and the event data 901-5 to the servers 102-A, 102-B, and 102-C.

As load information, for example, a head travel distance in reading event data, which is a read target, may be used. In this case, the servers 102-A, 102-B, and 102-C generate, as load information, a difference between a start address of event data, among pieces of event data that are read targets, which is the smallest and a start address of event data, among the pieces of event data, which is the largest.

In the example of FIG. 14, for the server 102-A, load information is “0x240000000−0x180000000=0xC0000000”. Similarly, for the servers 102-B and 102-C, load information is “0x1C0100000−0x1C0000000=0x100000”. The servers 102-A, 102-B, and 102-C transmit the generated load information to the storage control device 101. With reference to the received load information, the storage control device 101 determines, as a server from which the event data 901-4 and the event data 901-5 are read, one of the servers 102-B and 102-C for which a value indicated by the load information is the smaller.

Then, the storage control device 101 issues a read request for reading the event data 901-4 and the event data 901-5 to the determined server and receives the event data 901-4 and the event data 901-5 from the determined server. Next, the storage control device 101 transmits the event data 901-4 and the event data 901-5, which the storage control device 101 received, to the client device 201.

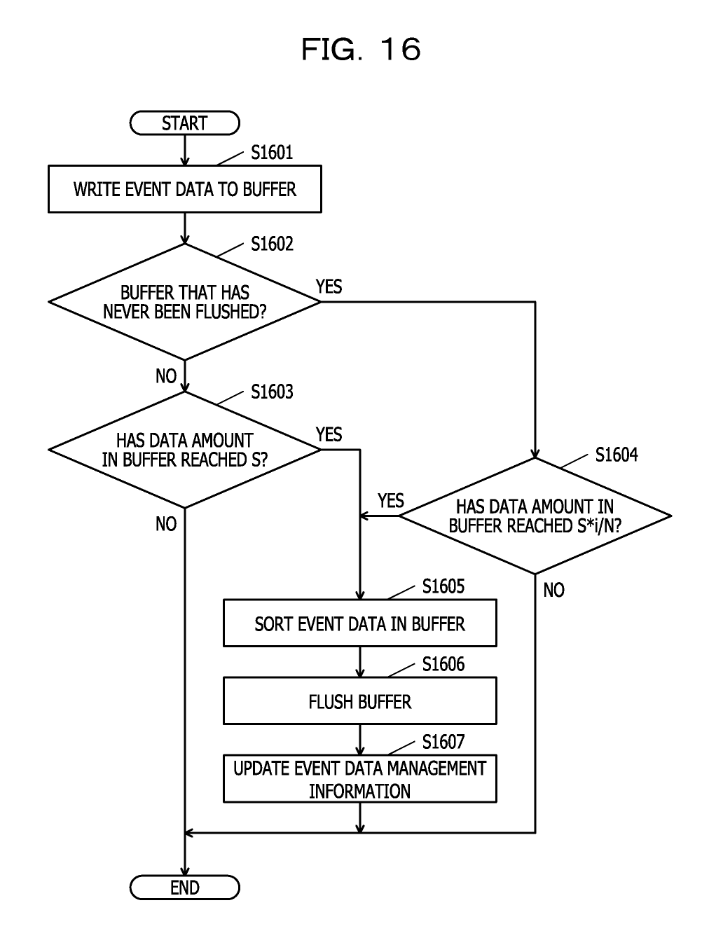

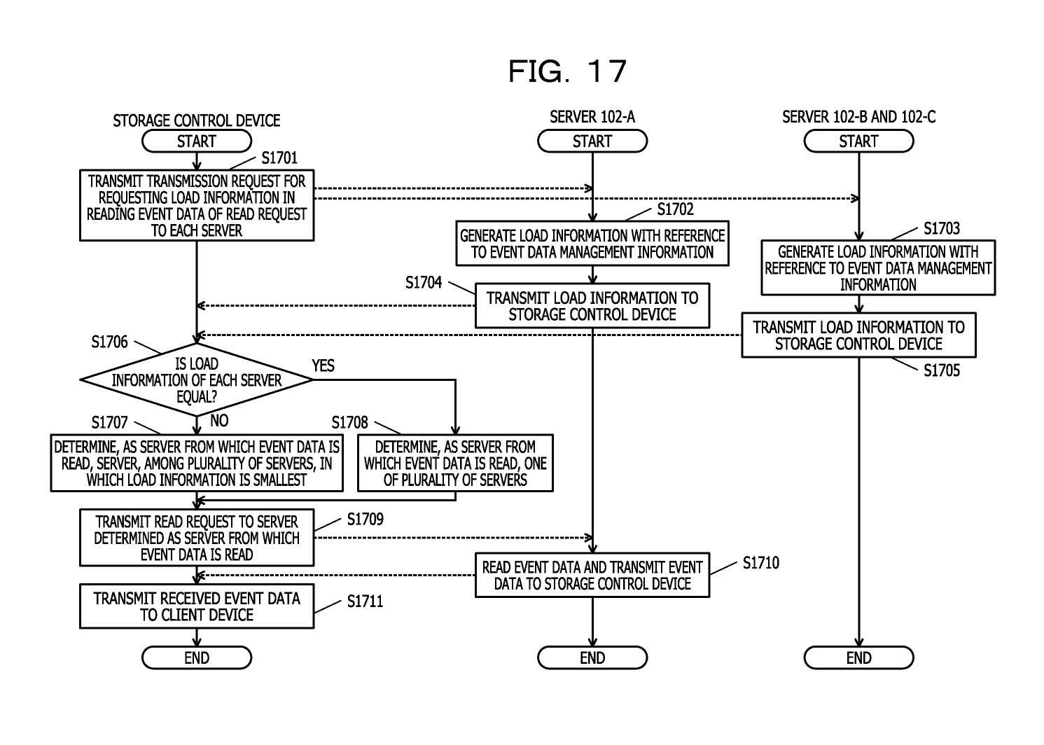

Next, each of FIG. 15, FIG. 16, and FIG. 17 illustrates a flow chart of processing executed by the storage system 100.

FIG. 15 is a flow chart illustrating an example of initialization processing procedures. The initialization processing is processing of initializing the storage system 100. The initialization processing is performed before the storage control device 101 receives the stream data 411.

The storage control device 101 broadcast-transmits a heart beat request to the servers 102-A, 102-B, and 102-C(Step S1501). After transmitting the heart beat request, the storage control device 101 awaits until a response is transmitted from the servers 102-A, 102-B, and 102-C. Each of the servers 102-A, 102-B, and 102-C that received the heart beat request transmits a response to the heart beat request to the storage control device 101 (Step S1502).

The storage control device 101 that received the response tallies the number N of servers from which the storage control device 101 received responses (Step S1503). Next, the storage control device 101 transmits N and a serial number i is to be allocated to each server to each of the servers 102-A, 102-B, and 102-C(Step S1504). By transmitting N and i, it is instructed to determine in which block each event data of the stream data 411 is written, based on N, i, and the data sizes of blocks. After the processing of Step S1504 is ended, the storage control device 101 ends the initialization processing.

The servers 102-A, 102-B, and 102-C that received N and i store N and i (Step S1505). After the processing of Step S1505 is ended, the servers 102-A, 102-B, and 102-C ends the initialization processing. The storage control device 101 may provide information used for causing the storage contents of the blocks of the servers 102-A, 102-B, and 102-C to differ among the servers 102-A, 102-B, and 102-C by executing initialization processing.

FIG. 16 is a flow chart illustrating an example of write processing procedures. The write processing is processing of writing event data to the servers 102-A, 102-B, and 102-C. The write processing is performed when the servers 102-A, 102-B, and 102-C receive a write request from the storage control device 101. Each step illustrated in FIG. 16 is performed by the servers 102-A, 102-B, and 102-C, but in the following description, an example in which the server 102-A performs write processing will be described for the sake of simplification.

The server 102-A writes event data in a buffer (Step S1601). Next, the server 102-A determines whether or not the buffer is a buffer that has never been flushed (Step S1602). If the buffer is a buffer that has been flushed once or more times (NO in Step S1602), the server 102-A determines whether or not the data amount in the buffer has reached S (Step S1603). If the data amount in the buffer has not reached S (NO in Step S1603), the server 102-A ends the write processing.

On the other hand, if the buffer is a buffer that has never been flushed (YES in Step S1602), the server 102-A determines whether or not the data amount in the buffer has reached S*i/N (Step S1604). If the data amount in the buffer has not reached S*i/N (NO in Step S1604), the server 102-A ends the write processing.

On the other hand, if the data amount in the buffer has reached S, or if the data amount in the buffer has reached S*i/N (YES in Step S1603, YES in Step S1604), the server 102-A sorts event data in the buffer (Step S1605). Next, the server 102-A flushes the buffer (Step S1606). Then, the server 102-A updates the event data management information 711-A (Step S1607). As specific update contents, the server 102-A writes the event data ID of event data stored in the buffer and the start address and the data size when the event data was written in a block to the event data management information 711. After the processing of the Step S1607 is ended, the server 102-A ends write processing. The server 102-A may cause the storage contents of blocks of the server 102-A itself to differ from the storage contents of blocks of the other servers by executing the write processing.

FIG. 17 is a flow chart illustrating an example of read processing procedures. The read processing is processing of reading event data, which is a read target, from one of the servers 102-A, 102-B, and 102-C. The read processing is performed by the storage control device 101 and the servers 102-A, 102-B, and 102-C in cooperation. In the example of FIG. 17, it is assumed that the load information of the server 102-A is the smallest and the storage control device 101 reads event data, which is a read target, from the server 102-A.

The storage control device 101 transmits a transmission request for transmitting load information regarding a load imposed in reading event data of a read request to each server (Step S1701). The servers 102-A, 102-B, and 102-C that received the transmission request generate load information with reference to the event data management information 711 (Step S1702, Step S1703). Then, each of the servers 102-A, 102-B, and 102-C transmits the load information to the storage control device 101 (Step S1704, Step S1705). Each of the servers 102-B and 102-C, except for the server 102-A the load information of which is the smallest, ends the reading processing after Step S1705 is ended.

The storage control device 101 that received the load information from each of the servers 102-A, 102-B, and 102-C determines whether or not the load information of each server is equal to those of the other servers (Step S1706). If the load information of each server differs from those of the other servers (NO in Step S1706), the storage control device 101 determines, as a server from which the event data of the read request is read, one of the plurality of servers the load information of which is the smallest (Step S1707). In the example of FIG. 17, the storage control device 101 determines the server 102-A as a server from which the event data of the read request is read. On the other hand, if the load information of each server is equal to those of the other servers (YES in Step S1706), the storage control device 101 determines one of the plurality of servers as a server from which the event data of the read request is read (Step S1708).

After Step S1707 or Step S1708 is ended, the storage control device 101 transmits the read request to the server determined as a server from which the event data is read (Step S1709). In the example of FIG. 17, the storage control device 101 transmits the read request to the server 102-A.

The server 102-A that received the read request reads the event data of the read request and transmits the event data to the storage control device 101 (Step S1710). After the processing of Step S1710 is ended, the server 102-A ends the read processing. The storage control device 101 that received the event data transmits the received event data to the client device 201 (Step S1711). After the processing of Step S1711 is ended, the storage control device 101 ends the read processing. The storage control device 101 may read the event data from the server 102 in which a load imposed in reading is the smallest by executing the read processing.

As described above, with the storage system 100, a server from which data is read is determined, based on a load imposed in reading data in each of servers that store data through mirroring such that storage contents of blocks differ among the servers. Thus, since the storage contents of blocks differ among the servers, loads in the servers are different from one another, and therefore, data may be read from one of the servers in which a load is small, so that the storage system 100 may reduce a load imposed in reading read target data from one of the servers 102-A, 102-B, and 102-C. The storage system 100 may read target data fast by reducing a load.

With the storage system 100, if the number of pieces of read target data is two or more, a server from which target data is read may be determined, based on a difference among addresses each of which indicates a storage position in which read target data is stored as the load information in the corresponding one of the servers 102-A, 102-B, and 102-C. Thus, the read target data may be read from a server in which the head travel distance is the smallest and a load imposed in reading in the storage system 100 may be reduced. Since a load imposed in reading in the storage system 100 may be reduced, reduction in write performance due to a conflict with a read access may be reduced. Moreover, since read target data is read from a server in which a head travel distance is the smallest, a response time for responding to a read request issued by the client device 201 may be reduced. This embodiment is effective for a storage device, such as a hard disk, which is excellent at sequential access and is poor at random access.

With the storage system 100, an instruction for determining a block in which data is written, based on the number of a plurality of servers, integers allocated to the servers 102-A, 102-B, and 102-C, and a predetermined data size, is transmitted to the servers 102-A, 102-B, and 102-C. Thus, the storage system 100 may ensure that storage contents of blocks differ among the servers 102-A, 102-B, and 102-C.

With the servers 102-A, 102-B, and 102-C, two or more pieces of event data belonging to one of blocks may be rearranged in accordance with a predetermined metadata value associated to each of the two or more pieces of event data and may be thus written in one of the blocks. Thus, the servers 102-A, 102-B, and 102-C may enable reduction in a load imposed in reading with respect to a read request for reading the two or more pieces of event data the metadata values of which match or are close to one another.

A plurality of pieces of data may be stream data, which is time-series data. If a plurality of pieces of data is stream data, a read request for reading two or more pieces of event data, which are temporarily consecutive, in the stream data tends to be issued. Thus, there are only few cases where the pieces of event data requested by the read request disperse across different blocks of the servers 102-A, 102-B, and 102-C. Therefore, when this embodiment is implemented, all of pieces of event data requested by a read request are in different blocks, and a probability that a load imposed in reading in each server is the same, from whichever of the servers the read target data is read, and advantages are not achieved is reduced.

Note that, the storage information extraction method described in this embodiment may be realized by causing a computer, such as a personal computer, a work station, and the like, to execute a program prepared in advance. The storage information extraction program is recorded in a computer-readable recording medium, such as a hard disk, a flexible disk, a compact disc-read only memory (CD-ROM), a digital versatile disk (DVD), and the like, is read by the computer from the recording medium, and thereby is executed. This storage information extraction program may be distributed via a network, such as the Internet, and the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control device comprising:
a memory configured to store data to be stored in a plurality of server apparatuses; and
a processor configured to
receive, from each of the plurality of server apparatuses, load information indicating degree of load for reading target data from a storage area included in each of the plurality of server apparatuses, the target data being stored as a mirroring data in each of the plurality of server apparatuses at a different portion of each respective storage area, and
determine, based on the load information received from each of the servers, a server apparatus, among the plurality of server apparatuses, from which the target data is read.

2. The control device according to claim 1, wherein
the target data includes a plurality of pieces of data stored in two or more of a plurality of portions of storage area,
the load information, received from each of the plurality of server apparatuses, includes difference information indicating difference among each of address information of the two or more of the plurality of portions of storage area at which the plurality of pieces of data are stored in corresponding one of the plurality of server apparatuses, and
the processor is configured to determine a server apparatus, among the plurality of server apparatuses, from which the target data is read, based on the difference information included in the load information.

3. The control device according to claim 1, wherein
the processor is configured to transmit an instruction to write the target data to each of the plurality of server apparatuses with control information which is used to write the target data to the different portion of storage area in each of the plurality of server apparatuses.

4. The control device according to claim 3, wherein
the control information includes an instruction to determine a storage area in which the target data is to be written, based on unique control information allocated to each of the server apparatuses, the unique control information being used to determine the different portion of storage area at which the target data is to be written.

5. A system comprising:
the control device according to claim 1; and
the plurality of server apparatuses each of which is configured to
receive, from the control device, a transmission request to transmit the load information indicating the degree of the load for reading the target data from each storage area included in each of the plurality of server apparatuses,
generate the load information when the transmission request is received, and
transmit the generated load information to the control device.

6. The system according to claim 5, wherein
each of the plurality of server apparatuses is configured to generate the load information, based on position information of the storage area at which the target data is stored.

7. The system according to claim 5, wherein
the target data includes a plurality of pieces of data stored in two or more of a plurality of portions of storage area, and
each of the plurality of server apparatuses is configured to generate the load information by including address information of the two or more of the plurality of portions of storage area at which the plurality of pieces of data are stored in the corresponding one of the plurality of server apparatuses.

8. The system according to claim 5, wherein
the processor of the control device is configured to transmit an instruction to write the target data to each of the plurality of server apparatuses with unique control information allocated to each of the server apparatuses which is used to write the target data to the different portion of storage area in each of the plurality of server apparatuses, and
each of the plurality of server apparatuses is configured to determine, in response to receiving the instruction from the control device, portion of storage area at which the target data is stored, based on the unique control information.

9. The system according to claim 7, wherein
each of the plurality of pieces of data is data associated with a predetermined attribute value, and
each of the plurality of server apparatuses is configured to
rearrange two or more of the plurality of pieces of data in accordance with the predetermined attribute value associated with each of the two or more pieces of data, and
write the rearranged two or more of the plurality of pieces of data in one of the plurality of portions of storage area.

10. The system according to claim 1,
wherein the plurality of pieces of data is time-series data.

11. A method comprising:
receiving, by a processor, from each of a plurality of server apparatuses, load information indicating degree of load for reading target data from a storage area included in each of the plurality of server apparatuses, the target data being stored as a mirroring data in each of the plurality of server apparatuses at a different portion of each respective storage area; and
determining, by the processor, a server apparatus, among the plurality of server apparatuses, from which the target data is read, based on the load information received from each of the servers.

12. The method according to claim 11, wherein
the target data includes a plurality of pieces of data stored in two or more of a plurality of portions of storage area,
the load information, received from each of the plurality of server apparatuses, includes difference information indicating difference among each of address information of two or more of the plurality of portions of storage area at which the plurality of pieces of data are stored in corresponding one of the plurality of server apparatuses, and
the determining includes determining a server apparatus, among the plurality of server apparatuses, from which the target data is read, based on the difference information included in the load information.

13. The method according to claim 11, further comprising:
transmitting, by the processor, an instruction to write the target data to each of the plurality of server apparatuses with control information which is used to write the target data to a different portion of storage area in each of the plurality of server apparatuses.

14. The method according to claim 13, wherein
the control information includes an instruction to determine a storage area in which the target data is to be written, based on unique control information allocated to each of the server apparatuses, the unique control information being used to determine the different portion of storage area at which the target data is to be written.

15. A non-transitory computer readable medium having stored therein a program for causing the computer to execute a process, the process comprising:
receiving, from each of a plurality of server apparatuses, load information indicating degree of load for reading target data from a storage area included in each of the plurality of server apparatuses, the target data being stored as a mirroring data in each of the plurality of server apparatuses at a different portion of each respective storage area; and
determining, based on the load information received from each of the servers, a server apparatus, among the plurality of server apparatuses, from which the target data is read.

16. The non-transitory computer readable medium according to claim 15, wherein
the target data includes a plurality of pieces of data stored in two or more of a plurality of portions of storage area,
the load information, received from each of the plurality of server apparatuses, includes difference information indicating difference among each of address information of the two or more of the plurality of portions of storage area at which the plurality of pieces of data are stored in corresponding one of the plurality of server apparatuses, and
the process further comprising determining a server apparatus, among the plurality of server apparatuses, from which the target data is read, based on the difference information included in the load information.

17. The non-transitory computer readable medium according to claim 15, wherein the process further comprising transmitting an instruction to write the target data to each of the plurality of server apparatuses with control information which is used to write the target data to the different portion of storage area in each of the plurality of server apparatuses.

18. The non-transitory computer readable medium according to claim 17, wherein the control information includes an instruction to determine a storage area in which the target data is to be written, based on unique control information allocated to each of the server apparatuses, the unique control information being used to determine the different portion of storage area at which the target data is to be written.
